(19) United States
(12) Patent Application Publication
(10) Pub. No.: US 2007/0115418 A1
(43) Pub. Date: May 24, 2007

(54) Liquid crystal display panel having layout of wires for different driving integrated circuits

(75) Inventors: Chien-Jen Chang, Miao-Li (TW); Hsien-Ying Chou, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/601,884

(22) Filed: Nov. 20, 2006

(30) Foreign Application Priority Data
Nov. 18, 2005 (TW) 94140620

(51) Int. Cl. G02F 1/1345

(52) U.S. Cl. 349/149

(57) ABSTRACT

An exemplary liquid crystal display (LCD) panel includes a substrate (21). The substrate includes a driving integrated circuit (IC) area (22) configured to be connected to either a first driving IC having a first size or a second driving IC having a second size. The driving IC area (22) includes a plurality of connecting wires (28), a plurality of first input metal pads (24), a plurality of second input metal pads (27), and a plurality of output metal pads (23). The first input metal pads and the output metal pads are configured for electrical connection with the first driving IC. The second input metal pads and the output metal pads are configured for electrical connection with the second driving IC. The first input metal pads are connected to the second input metal pads via the connecting wires, respectively.

### TECHNICAL FIELD

The present invention relates to a liquid crystal display (LCD) panel having a layout of wires that allows either of two different driving ICs having two different sizes to be connected to the wires.

### BACKGROUND

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions. A main component of an LCD is an LCD panel, which includes a display screen.

During a typical process for fabricating an LCD panel, a driving integrated circuit (IC) used for driving the LCD panel is fixed on a glass substrate of the LCD panel by a chip on glass (COG) technique. The LCD panel also includes a layout of wires formed on the substrate, for connecting to the driving IC. Normally, two kinds of driving ICs can be used to drive an LCD panel. One kind has a memory unit with numerous functions for driving the LCD panel. The other kind has no memory unit and is small.

FIG. 2 is a schematic, abbreviated, top plan view of certain parts of a typical LCD panel that is configured to have a driving IC without memory. The LCD panel 10 includes a substrate 1. The substrate 1 includes a driving IC area 2, a plurality of input wires 5, and a plurality of output wires 6. The driving IC area 2 has a plurality of input metal pads 4 arranged in a first row, and a plurality of output metal pads 3 arranged in a second row parallel to the first row. The input metal pads 4 and the output metal pads 3 are used to connect with a driving IC (not shown) that does not have a memory unit. A width of the driving IC is approximately equal to a width WI of the driving IC area 2. That is, a configuration of the driving IC corresponds to the driving IC area 2, so that the driving IC can be properly attached on the driving IC area 2. The output metal pads 3 are connected to a plurality of data lines (not shown) of the LCD panel 10 via the output wires 6 respectively. The input metal pads 4 are connected to a flexible printed circuit board (not shown) of the associated LCD via the input wires 5.

FIG. 3 is a schematic, abbreviated, top plan view of certain parts of a typical LCD panel that is configured to have a driving IC with memory. The LCD panel 20 includes a substrate 11. The substrate 11 includes a driving IC area 12, a plurality of input wires 15, and a plurality of output wires 16. The driving IC area 12 has a plurality of input metal pads 14 arranged in a first row, and a plurality of output metal pads 13 arranged in a second row parallel to the first row. The input metal pads 14 and the output metal pads 13 are used to connect with a driving IC (not shown) that has a memory unit. The memory unit can, for example, be a random access memory (RAM). A width of the driving IC is approximately equal to a width W2 of the driving IC area 12 (W2>W1). That is, a configuration of the driving IC corresponds to the driving IC area 12, so that the driving IC can be properly attached on the driving IC area 12. The output metal pads 13 are connected to a circuit (not shown) of the LCD panel 20 via the output wires 16. The input metal pads 14 are connected to an associated external circuit (not shown) via the input wires 15.

A driving IC with RAM and a driving IC without RAM can each be used to drive a same LCD panel of an LCD which has a predetermined resolution, such as an LCD with a video graphics array (VGA) or a super video graphics array (SVGA). As seen above, the two different driving ICs have different physical configurations and occupy different amounts of space. Thus mass production of a same LCD panel in two versions corresponding to the two kinds of driving ICs also requires two versions of the LCD panel itself to be made. That is, as seen above, one kind of LCD panel 10 with a certain layout of wires is needed for the driving IC without RAM, and another kind of LCD panel 20 with a certain layout of wires is needed for the driving IC with RAM. This increases the cost of mass production of the LCD.

It is desired to provide an LCD which overcomes the above-described deficiencies.

### SUMMARY

In one preferred embodiment, an exemplary LCD panel includes a substrate. The substrate includes a driving IC area configured to be connected to either a first driving IC having a first size or a second driving IC having a second size. The driving IC area includes a plurality of connecting wires, a plurality of first input metal pads, a plurality of second input metal pads, and a plurality of output metal pads. The first input metal pads and the output metal pads are configured for electrical connection with the first driving IC. The second input metal pads and the output metal pads are configured for electrical connection with the second driving IC. The first input metal pads are connected to the second input metal pads via the connecting wires, respectively.

Advantages and novel features of the above-described LCD panel will become more apparent from the following detailed description when taken in conjunction with the accompanying drawings, in which:

### BRIEF DESCRIPTION OF THE DRAWINGS

FIG. 1 is a schematic, abbreviated, top plan view of certain parts of an LCD panel according to a preferred embodiment of the present invention;

FIG. 2 is a schematic, abbreviated, top plan view of certain parts of a conventional LCD panel that is configured to have a driving IC without memory; and

FIG. 3 is a schematic, abbreviated, top plan view of certain parts of a conventional LCD panel that is configured to have a driving IC with memory.

### DETAILED DESCRIPTION OF PREFERRED EMBODIMENTS

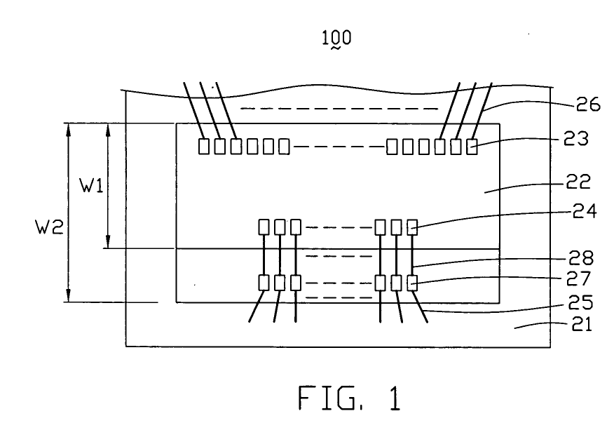

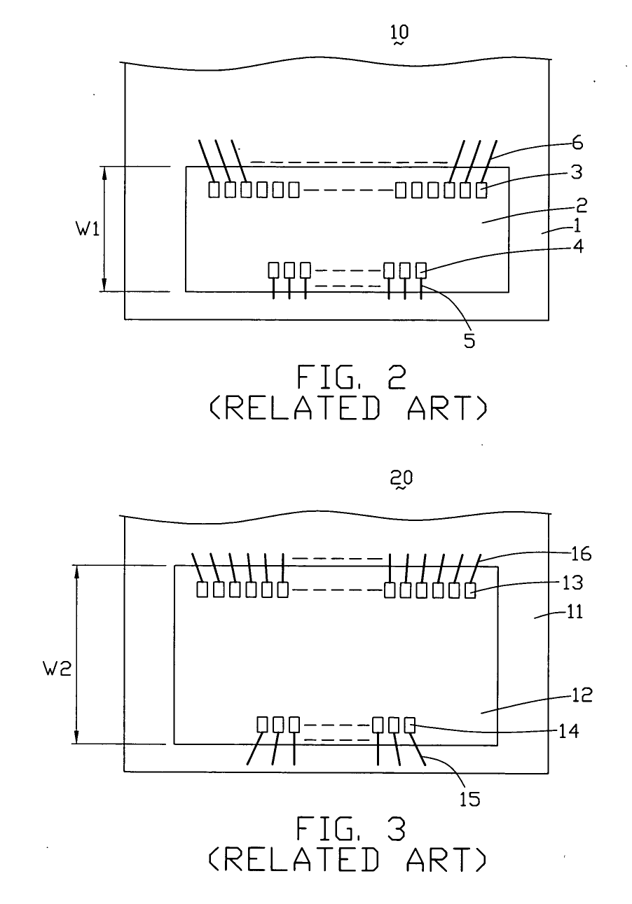

FIG. 1 is a schematic, abbreviated, top plan view of certain parts of an LCD panel according to a preferred embodiment of the present invention. The LCD panel 100 includes a substrate 21. The substrate 21 includes a driving IC area 22, a plurality of input wires 25, a plurality of output wires 26, and a plurality of connecting wires 28. The driving IC area 22 has a plurality of first input metal pads 24 arranged in a first row, a plurality of second input metal pads 27 arranged in a second row parallel to the first row, and a plurality of output metal pads 23 arranged in a third row parallel to the first and second rows. The row of first input metal pads 24 is located between the row of second input metal pads 27 and the row of output pads 23.

The output metal pads 23 are connected to a plurality of data lines (not shown) of the LCD panel 100 via the output wires 26. The first input metal pads 24 are respectively connected to the second input metal pads 27 via the connecting wires 28. The second input metal pads 27 are connected to a flexible printed circuit board (not shown) of an associated LCD via the input wires 25.

The first input metal pads 24 and the output metal pads 23 are used to connect with a first driving IC (not shown) that does not have a memory unit. The second input metal pads 27 and the output metal pads 23 are used to connect with a second driving IC that has a memory unit. The memory unit can, for example, be a RAM.

A first distance spanning the row of first input metal pads 24 and the row of output metal pads 23 is defined as W1. A width of the first driving IC is approximately equal to W1. A second distance spanning the row of second input metal pads 27 and the row of output metal pads 23 is defined as W2 (W2>W1). A width of the second driving IC is approximately equal to W2. That is, a size of the second driving IC is larger than that of the first driving IC.

Because the LCD panel 100 includes the driving IC area 22 having the first and second input metal pads 24, 27 and the output metal pads 23, a driving IC with RAM or a driving IC without RAM can be chosen to be fixed on the LCD panel 100. That is, a selected one of the two kinds of driving ICs can be fixed at a corresponding position on the driving IC area 22. Unlike with conventional LCD panels, there is no need to make two versions of an LCD panel in order to be able to apply the two kinds of driving ICs. Thus the cost of mass manufacture of the LCD panel 100 having either of the two kinds of driving ICs is reduced.

The LCD panel 100 can of course be used for other kinds of driving ICs besides those described above. For example, a first kind of driving IC may have a memory other than a RAM. A second kind of driving IC may also have a memory, albeit one that allows the second kind of driving IC to have a smaller size. Such kind of memory can, for example, be a so-called partial RAM. A first kind of driving IC may have a larger size by reason of another constituent thereof besides a memory. Correspondingly, a second kind of driving IC may lack this constituent.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in matters of shape, size, and arrangement of parts within the principles of present invention to the full extent indicated by the broad general meaning of the terms in which the appended claims are expressed.

What is claimed is:

1. A liquid crystal display (LCD) panel, the LCD panel comprising a substrate, the substrate comprising a driving integrated circuit (IC) area configured to be connected to either a first driving integrated circuit (IC) having a first size or a second driving IC having a second size, the driving IC area comprising:
a plurality of connecting wires;
a plurality of first input metal pads;
a plurality of second input metal pads; and
a plurality of output metal pads;
wherein the first input metal pads are connected to the second input metal pads via the connecting wires respectively, the first input metal pads and the output metal pads are configured for electrical connection with the first driving IC, and the second input metal pads and the output metal pads are configured for electrical connection with the second driving IC.

2. The LCD panel as claimed in claim 1, wherein the first input metal pads are arranged in a first row.

3. The LCD panel as claimed in claim 2, wherein the second input metal pads are arranged in a second row parallel to the first row.

4. The LCD panel as claimed in claim 3, wherein the output metal pads are arranged in a third row parallel to the first and second rows, with the first row located between the second row and the third row.

5. A liquid crystal display (LCD) panel, the LCD panel comprising a substrate, the substrate comprising a driving integrated circuit (IC) area and a driving IC attached on the driving IC area, the driving IC area comprising:
a plurality of connecting wires
a plurality of first input metal pads;
a plurality of second input metal pads; and
a plurality of output metal pads;
wherein the first input metal pads are connected to the second input metal pads via the connecting wires respectively, the first input metal pads are arranged in a first row, the second input metal pads are arranged in a second row, the output metal pads are arranged in a third row, the first row is positioned between the second row and the third row; and
the driving IC is either electrically connected with the first input metal pads and the output metal pads, or electrically connected with the second input metal pads and the output metal pads.

6. The LCD panel as claimed in claim 5, wherein the driving IC is electrically connected with the first input metal pads and the output metal pads.

7. The LCD panel as claimed in claim 6, wherein a width of the driving IC corresponds to a distance between the row of first input metal pads and the row of output metal pads.

8. The LCD panel as claimed in claim 5, wherein the driving IC is electrically connected with the second input metal pads and the output metal pads.

9. The LCD panel as claimed in claim 8, wherein a width of the driving IC corresponds to a distance between the row of second input metal pads and the row of output metal pads.

10. The LCD panel as claimed in claim 9, wherein the driving IC comprises a memory.

11. The LCD panel as claimed in claim 10, wherein the memory comprises a random access memory (RAM).

12. A liquid crystal display (LCD) panel, the LCD panel comprising a substrate, the substrate comprising a driving integrated circuit (IC) area configured to be connected to either a first driving integrated circuit (IC) having a first size or a second driving IC having a second size, the driving IC area comprising:
a plurality of first input metal pads;
a plurality of second input metal pads; and
a plurality of output metal pads;
wherein the first input metal pads and the output metal pads are spaced and configured to fit the first driving IC, and the second input metal pads and the output metal pads are spaced and configured to fit the second driving IC, under a condition that both the first input metal pads and the second input metal pads are located on a same side with regard to the out put metal pads.
